(19) United States
(12) Patent Application Publication
(10) Pub. No.: US 2010/0107122 A1
(43) Pub. Date: Apr. 29, 2010

(54) System for Providing Widget Type Idle-Screen

(75) Inventor: Hoon Jung, Yongin-si (KR)

Correspondence Address: INTELLECTUAL PROPERTY LAW GROUP LLP, 12 SOUTH FIRST STREET, SUITE 1205, SAN JOSE, CA, 95113, US

(73) Assignee: Minigate Co. Ltd., Seoul (KR)

(21) Appl. No.: 12/430,856

(22) Filed: Apr. 27, 2009

(30) Foreign Application Priority Data
Oct. 24, 2008 (KR) 10-2008-0105035

(51) Int. Cl. G06F 3/048; G06F 15/16; G06F 7/06; G06F 17/30

(52) U.S. Cl. 715/826; 709/203; 707/E17.032; 707/E17.044

(57) ABSTRACT

Provided is a system for providing a widget type idle-screen. The system includes a management server, a database, and a user terminal. The database is managed by the management server, and stores and manages widget type idle-screen contents and a dedicated application for driving the widget type idle-screen contents. The user terminal downloads the widget type idle-screen contents from the database and includes the dedicated application for driving the widget type idle-screen contents. The widget type idle-screen contents are activated on the screen of the user terminal in connection with a phone number of a receiver terminal during the standby time of an outgoing call.

### CROSS-REFERENCE TO RELATED APPLICATIONS

This application claims priority under 35 U.S.C. § 119 to Korean Patent Application No. 10-2008-0105035, filed on Oct. 24, 2008, the disclosure of which is incorporated herein by reference in its entirety.

### TECHNICAL FIELD

The present invention relates to a system for providing a widget type idle-screen, and in particular, to a system for providing a widget type idle-screen that can provide substantial and useful information to a sender trying to make a call or a receiver through an idle-screen on a mobile phone terminal.

### BACKGROUND

In the context of our rapid transformation to an information and communication society, the Internet and mobile communication service have become longstanding necessities for people living in the modern society.

Mobile communication technology in particular, a fast-emerging and high technology-intensive branch of the information and communication technology field, is being diversified into various technological industries to create significant value-added.

In-line with this trend, most people have at least one personal terminal such as a computer or mobile phone. Recently, in the case of mobile communication terminals such as mobile phones, the markets for the terminals themselves and value-added service for terminals are rapidly expanding. Representative examples of mobile communication terminal-related value-added services include ringtones, ringback tones, and idle-screen graphic contents services.

Ringback tone services have evolved from previous technologies such as the provision of contents like music to alleviate the monotony a caller waiting to talk may experience to recent technologies such as the provision of videos through videophones.

However, these typical ringback tone and video services are only capable of one-way provision of music and video stored in a server to the caller.

Therefore, a new method is required to provide more useful information to the sender or the receiver during call connecting.

### SUMMARY

Accordingly, the present disclosure provides a system for providing a widget type standby idle screen that can provide substantial and useful information to a sender trying to call or a receiver through an idle screen on a mobile phone terminal.

Objects of the present invention shall not be limited to the above, however, and further objects will become readily apparent to those skilled in the art from the description below.

According to an aspect of the present invention, there is provided a system for providing a widget type idle-screen, including: a management server; a database managed by the management server, and storing and managing widget type idle-screen contents and a dedicated application for driving the widget type idle-screen contents; and a user terminal downloading the widget type idle-screen contents from the database and comprising the dedicated application for driving the widget type idle-screen contents, the widget type idle-screen contents being activated on the screen of the user terminal in connection with a phone number of a receiver terminal or a sender terminal during the standby time of an outgoing call or an incoming call.

After being created by a user to be uploaded to the database through the management server, the widget type idle-screen contents may be selectively downloaded to the user terminal according to the user's demand. In this case, the widget type idle-screen contents may be created by a tool for manufacturing the widget type idle-screen contents provided from the management server, or selected by a user from a plurality of already-created widget type idle-screen contents.

The widget type idle-screen contents currently stored in the database may be confirmed and searched to be selectively downloaded to the user terminal.

The widget type idle-screen contents activated in connection with the phone number of the receiver terminal or the sender terminal may include extension number guidance, product and menu introductions, reservation or booking information, public opinion surveys, and guide or advertisement information.

In this case, the widget type idle-screen contents activated in connection with the phone number of the receiver terminal or the sender terminal may be maintained activated on the screen of the sender terminal or the receiver terminal even after communication between the sender terminal and the receiver terminal is established.

Also, the widget type idle-screen contents may be configured to provide an additional function of providing a detailed menu or additional information, and links for purchasing, reserving, or selecting extension numbers.

It will be understood by those skilled in the art that the widget type idle-screen contents downloaded to the user terminal and the application for driving the widget type idle-screen contents may be in real-time or periodically updated in connection with the management server.

If the widget type idle-screen contents in connection with the phone number of the receiver terminal or the sender terminal are not stored in the sender terminal or the receiver terminal, respectively, the widget type idle-screen contents may be downloaded in real-time. In this case, the real-time download of the widget type idle-screen contents may be performed according to whether the sender terminal or the receiver terminal allows the download of the widget type idle-screen contents.

If the widget type idle-screen contents stored in the database and the dedicated application for driving the widget type idle-screen contents may be updated, the management server may inform the user terminal.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

FIG. 1 is a diagram illustrating a configuration of a system for a widget type idle-screen according to an embodiment of the present invention; and

FIG. 2 is a diagram illustrating a configuration of a system for a widget type idle-screen according to another embodiment of the present invention.

### DETAILED DESCRIPTION OF EMBODIMENTS

The advantages, features and aspects of the present invention will become apparent from the following description of the embodiments with reference to the accompanying drawings, which is set forth hereinafter. The present invention may, however, be embodied in different forms and should not be construed as limited to the embodiments set forth herein. Rather, these embodiments are provided so that this disclosure will be thorough and complete, and will fully convey the scope of the present invention to those skilled in the art. Like reference numerals refer to like elements throughout.

It will be understood that, although the terms first and second are used herein to describe various devices, elements and sections, these devices, elements and sections should not be limited by these terms. These terms are only used to distinguish one device, element and section from another device, element and section. It will, therefore, be understood that a first device, first element and first section may be a second device, second device and second section within the technical spirit of the present invention.

As used herein, the singular forms “a,” “an” and “the” are intended to include the plural forms as well, unless the context clearly indicates otherwise. It will be further understood that the terms “comprises (includes)” and/or “comprising (including),” when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein

The present invention has been described with reference to flowchart illustrations and/or flow diagrams of methods, apparatus (systems), and computer program products according to embodiments of the invention. It will be understood that each block of the flowchart illustrations and/or flow diagrams, and combinations of blocks in the flowchart illustrations and/or flows in the flow diagrams, can be implemented by computer program instructions. These computer program instructions may be provided to a processor of a general purpose computer, special purpose computer, embedded processor, or other programmable data processing apparatus to produce a machine, such that the instructions, which execute via the processor of the computer or other programmable data processing apparatus, create means for implementing the functions specified in the flowchart and/or flow diagram block(s) or flow(s). These computer program instructions may also be stored in a computer-readable memory that can direct a computer or other programmable data processing apparatus to function in a particular manner, such that the instructions stored in the computer-readable memory produce an article of manufacture including instruction means which implement the function specified in the flowchart and/or flow diagram block(s) or flow(s). The computer program instructions may also be loaded onto a computer or other programmable data processing apparatus to cause a series of operational steps to be performed on the computer or other programmable apparatus to produce a computer-implemented process such that the instructions which execute on the computer or other programmable apparatus provide steps for implementing the functions specified in the flowchart and/or flow diagram block(s) or flow(s). Furthermore, the instructions may be executed by more than one computer or data processing apparatus.

Hereinafter, exemplary embodiments of the present invention will be described in detail with reference to the accompanying drawings.

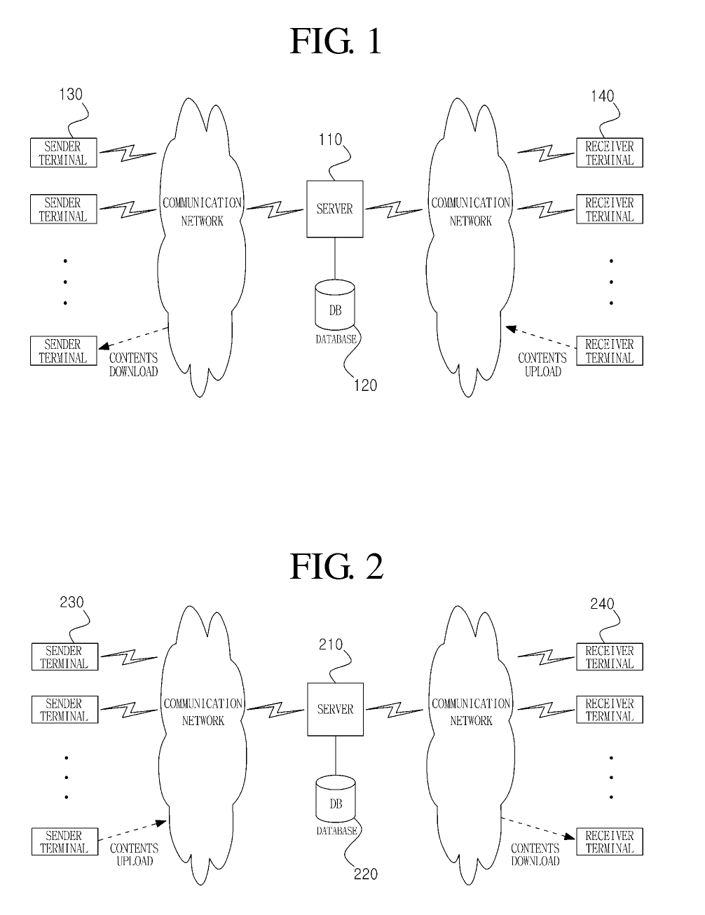

FIG. 1 is a diagram illustrating a configuration of a system for a widget type idle-screen according to an embodiment of the present invention.

Referring to FIG. 1, the system for a widget type idle-screen includes a management server 110, database 120, and user terminals 130 and 140.

The management server 110 performs functions of relaying a communication between the user terminals 130 and 140 for transmission and reception, and of managing the database 120. The database 120 controlled by the management server 110 performs a function of storing and managing widget type idle-screen contents and dedicated applications for driving the contents.

In this case, after being created by users to be uploaded to the management server 110, the widget type idle-screen contents (that are stored and managed in the database 120) may be configured to be selectively downloaded to the user terminals 130 and 140 requiring the contents. That is, as illustrated in the drawing, after being stored in the database 120 through the receiver terminal 140, the widget type idle-screen contents are activated on the sender terminal 130 when a call is generated from the sender terminal 130 (that downloaded the stored data) to the receiver terminal 140.

In this case, the widget type idle-screen contents may be uploaded so as to be created by a tool for manufacturing the widget type idle-screen, or be selected by a user from the widget type idle-screen contents, but is not limited thereto.

In this case, the sender terminal 130 may be configured to confirm the total list of the widget type idle-screen contents currently stored in the database 120 and selectively download them, and may be configured to have a criteria search function using keywords designated when uploaded through the receiver terminal 140, upload dates, and download popularity.

The widget type idle-screen contents uploaded and downloaded through the above process are activated in connection with the telephone number of the specific receiver terminal 140 when the sender terminal 130 mounted with the dedicated application for driving the widget type idle-screen contents downloaded from the database 120 stands by for an outgoing call to the receiver terminal 140.

In this case, the widget type idle-screen contents applied to the system for providing the widget type idle-screen according to the embodiment of the present invention may include extension number guidance, product or menu descriptions, and advertisement information. For example, if the widget type idle-screen contents are related to a general phone number of a company, information on extension numbers to the general telephone number may be provided through the idle-screen to enhance user convenience and shorten call duration. If the widget type idle-screen contents are related to a phone number of a restaurant or a merchandise store, information on the menu or the products of the corresponding restaurant or merchandise store may be provided for user convenience and efficiency.

In addition, the widget type idle-screen contents may be activated on the screen of the sender terminal even after the sender terminal is connected to the receiver terminal, so that the extension number guidance, the menu or product information, and the advertisement information as exemplified above can be additionally provided, and a further function of providing additional information or connecting to an extension number selected by a user can be performed. That is, if the contents are related to the company extension number guidance, the sender terminal can be connected to the corresponding extension number by clicking the extension number provided on the idle-screen after the call connection. If the contents are related to the products or menu information service, the user can obtain more detailed information on the products or the menu, or order from the product list or menu.

However, the present invention should not be construed as limited to the embodiments and examples set forth herein. It will be also understood by those skilled in the art that the widget type idle-screen contents, in addition to extension number guidance and product description services, may include various information services such as ticket reservation services and restaurant reservation services.

A system for providing widget type idle-screen contents according to an embodiment of the present invention may download the widget type idle-screen contents in real-time when the widget type idle-screen contents corresponding to the phone number of the receiver terminal are not stored in the sender terminal 130. That is, when the widget type idle-screen contents corresponding to the phone number of the receiver terminal 140 called by the sender terminal 130 are registered in the database 120 but not in the sender terminal 130, the management server 110 informs the sender terminal 130, and queries whether the sender terminal 130 will download the corresponding widget type idle-screen contents. In this case, the sender terminal 130 may download the corresponding widget type idle-screen contents according to a user's decision in response to the query.

Also, if the widget type idle-screen contents stored in the database 120 and the dedicated application for driving the widget type idle-screen contents are updated, the management server 110 may notify all or part of the user terminals 130 and 140 of the updated information. Moreover, the widget type idle-screen contents mounted in the user terminals 130 and 140 and the dedicated application for driving the widget type idle-screen contents may be automatically updated in real-time or periodically.

It will be understood by those skilled in the art that the user terminals 130 and 140 include various kinds of wireless communication terminals, wired communication terminals and phone service terminals using computers and the Internet, in addition to mobile communication terminals.

FIG. 2 is a diagram illustrating a configuration of a system for a widget type idle-screen according to another embodiment of the present invention.

Referring to FIG. 2, a system for providing a widget type idle-screen according to another embodiment of the present invention may include a management server 210, a database 220, and user terminals 230 and 240. As opposed to the depiction in FIG. 1, the widget type idle-screen may be activated in connection with the phone number of a sender dialing a receiver terminal.

Accordingly, there is a difference in that the widget type idle-screen contents are uploaded from the sender terminal 230, and are downloaded to the receiver terminal 240.

According to another embodiment of the present invention described in FIG. 2, because an idle-screen in connection with the phone number of the sender terminal 230 is activated during the standby time of the receiver terminal, the system for providing the widget type idle-screen may be used to provide various information services such as ticket reservation services and restaurant reservation services, in addition to the extension number guidance and the product description. More preferably, the system may be applied to an automated voice response phone guide of a poll or public service office, but is not limited thereto.

Detail functions such as uploading, downloading and using methods of other idle-screen contents will be described with reference to FIG. 1.

It will be understood by those skilled in the art that, as described above, the user terminals 230 and 240 include various kinds of wireless communication terminals, wired communication terminals and phone service terminals using computers and the Internet, in addition to mobile communication terminals.

According to the embodiments of the present invention, the system for providing the widget type idle-screen can provide a widget type idle-screen that a sender or a receiver of an attempted call using a mobile terminal can customize.

Accordingly, the system has an advantage of providing useful information such as product and menu information, or extension number guidance through the idle screen.

Also, the widget type idle-screen contents activated in connection with the phone number of the receiver terminal can be maintained activated on the screen of the sender terminal to provide additional services such as detailed menus and additional information services, and a connection to a desired extension number even after communication between the sender terminal and the receiver terminal is established.

Moreover, by selectively downloading from the list of the widget type idle-screen contents and downloading in real-time the widget type idle-screen contents immediately before a call connection is established, a user can download and update contents conveniently.

That is, unlike a typical idle screen intended simply to alleviate monotony or generate added value through advertisements, the system according to the embodiment of the present invention can provide more useful and substantial information to the user. Thus, the system has additional advantages such as making idle-screen use more efficient and reducing call duration.

While preferred embodiments of the present invention have been described, additional variations and modifications in those embodiments may occur to those skilled in the art once they learn of the basic inventive concepts. Therefore, it is intended that the appended claims shall be construed to include all such variations and modifications that fall within the spirit and scope of the invention.

I claim:

1. A system for providing a widget type idle-screen, comprising:
a management server;
a database managed by the management server, and storing and managing widget type idle-screen contents and a dedicated application for driving the widget type idle-screen contents; and
a user terminal downloading the widget type idle-screen contents from the database and comprising the dedicated application for driving the widget type idle-screen contents, the widget type idle-screen contents being activated on a screen of the user terminal in connection with a phone number of a receiver terminal during a standby time of an outgoing call.

2. The system of claim 1, wherein, after being created by a user to be uploaded to the database through the management server, the widget type idle-screen contents are selectively downloaded to the user terminal according to a command by the user.

3. The system of claim 1, wherein the widget type idle-screen contents are created by a tool for manufacturing the widget type idle-screen contents provided from the management server, or selected by a user from a plurality of already-created widget type idle-screen contents.

4. The system of claim 1, wherein the widget type idle-screen contents currently stored in the database are confirmed and searched to be selectively downloaded to the user terminal.

5. The system of claim 1, wherein the widget type idle-screen contents activated in connection with the phone number of the receiver terminal comprise extension number guidance, a product or menu introduction, reservation or booking information, a public opinion survey, and guidance or advertisement information.

6. The system of claim 5, wherein the widget type idle-screen contents activated in connection with the phone number of the receiver terminal are maintained activated on the screen of a sender terminal even after a communication between the sender terminal and the receiver terminal is established.

7. The system of claim 6, wherein the widget type idle-screen contents are configured to provide an additional function of providing detailed menu or additional information, and connecting for purchase, reservation, or a selected extension number.

8. The system of claim 5, wherein the widget type idle-screen contents downloaded to the user terminal and the application for driving the widget type idle-screen contents are in real-time or periodically updated in connection with the management server.

9. The system of claim 8, wherein, if the widget type idle-screen contents in connection with the phone number of the receiver terminal are not stored in a sender terminal, the widget type idle-screen contents are downloaded in real-time.

10. The system of claim 9, wherein the real-time download of the widget type idle-screen contents is performed according to whether the sender terminal allows the download of the widget type idle-screen contents.

11. The system of claim 8, wherein, if the widget type idle-screen contents stored in the database and the dedicated application for driving the widget type idle-screen contents are updated, the management server informs the user terminal.

12. A system for providing a widget type idle-screen, comprising:
a management server;
a database managed by the management server, and storing and managing widget type idle-screen contents and a dedicated application for driving the widget type idle-screen contents; and
a user terminal downloading the widget type idle-screen contents from the database and comprising the dedicated application for driving the widget type idle-screen contents, the widget type idle-screen contents being activated on a screen of the user terminal in connection with a phone number of a sender terminal during a standby time of an incoming call.

13. The system of claim 12, wherein the widget type idle-screen contents activated in connection with the phone number of the sender terminal comprise extension number guidance, a product or menu introduction, reservation or booking information, a public opinion survey, and guidance or advertisement information.

14. The system of claim 13, wherein the widget type idle-screen contents activated in connection with the phone number of the sender terminal are maintained activated on the screen of a sender terminal even after communication between the sender terminal and a receiver terminal is established.

15. The system of claim 14, wherein the widget type idle-screen contents are configured to provide an additional function of providing detailed menu or additional information, and connecting for purchase, reservation, or a selected extension number.

16. The system of claim 13, wherein the widget type idle-screen contents downloaded to the user terminal and the application for driving the widget type idle-screen contents are in real-time or periodically updated in connection with the management server.

17. The system of claim 16, wherein, if the widget type idle-screen contents in connection with the phone number of the sender terminal are not stored in a receiver terminal, the widget type idle-screen contents are downloaded in real-time.

18. The system of claim 17, wherein the real-time download of the widget type idle-screen contents is performed according to whether the receiver terminal allows the download of the widget type idle-screen contents.

19. The system of claim 16, wherein, if the widget type idle-screen contents stored in the database and the dedicated application for driving the widget type idle-screen contents are updated, the management server informs the user terminal.
